(19) United States
(12) Patent Application Publication
(10) Pub. No.: US 2010/0215948 A1
(43) Pub. Date: Aug. 26, 2010

(54) RUBBERY-BLOCK CONTAINING POLYMERS, FIBER SIZINGS THEREOF AND COMPOSITES THEREOF

(75) Inventors: Denis Kissounko, Elkton, MD (US); Katherine M. Danner, Colorado Springs, CO (US); Robert Barsotti, Drexel Hill, PA (US)

Correspondence Address: POTTER ANDERSON & CORROON LLP;ATTN: JANET E. REED, PH.D., P.O. BOX 951, WILMINGTON, DE, 19899-0951, US

(73) Assignees: University of Delaware, Newark, DE (US); Arkema Inc., Philadelphia, PA (US)

(21) Appl. No.: 12/708,907

(22) Filed: Feb. 19, 2010

Related U.S. Application Data
(60) Provisional application No. 61/154,054, filed on Feb. 20, 2009.

(51) Int. Cl. B32B 5/02; D02G 3/36; C08L 33/10; C08K 3/38; C08K 3/22; C08K 3/34; C08K 3/36; C08L 53/00; C08F 8/32

(52) U.S. Cl. 428/327; 428/378; 428/367; 524/523; 524/525; 524/404; 524/413; 524/445; 524/456; 524/437; 524/447; 525/94; 525/380; 977/742; 977/734

(57) ABSTRACT

The present invention relates generally to sizing compositions for fibers used in composite materials. More specifically, this invention relates to siloxane fiber sizing solutions comprising rubbery-polymers and their use in preparing composite materials. Using the sizings of the present invention not only improves the energy absorption of the composite materials made thereof, but also maintains the interfacial strength of composite materials. Particularly, the rubbery-polymers of the present invention are functionalized with chemical groups that react to the fiber surface and/or to the polymeric resin. In addition, because the rubbery-polymer is incorporated as one block of a block copolymer, it advantageously improves both, the interfacial strength and energy absorption.

### CROSS-REFERENCE TO RELATED APPLICATION

This application claims the benefit of U.S. Provisional Application No. 61/154,054 which was filed Feb. 20, 2009, of which is incorporated by reference herein in its entirety.

### FIELD OF INVENTION

The present invention relates generally to sizing compositions for fibers used in composite materials. More specifically, this invention relates to siloxane fiber sizing solutions comprising rubbery-polymers and their use in preparing composite materials. Using the sizings of the present invention not only improves the energy absorption of the composite materials made thereof, but also maintains the interfacial strength of composite materials.

### BACKGROUND

Fibers such as glass fibers and carbon fibers are commonly used as reinforcements in polymeric resin matrices. These reinforced materials are called fiber-reinforced plastics or composites. Such fibers advantageously reinforce the polymeric matrix properties such as dimensional stability, tensile strength, toughness, heat resistance, moisture resistance, and thermal conductivity.

The interphase layer between the fiber and the polymer matrix plays a pivotal role in defining mechanical properties of the composite material. Thus, accurately tailoring the interphase adhesion becomes important. Interphase adhesion, inter alia, depends on the degree of chemical bonding between the fiber and polymeric resin. For example, the chemical bonding helps achieve optimum stress transfer from the matrix through the interphase, and into the reinforcing fiber. For example, if compatible silane coupling agents are used, the Interfacial Shear Strength (IFSS) could be increased as much as 40% through controlled chemical bonding. However, for composite materials the increase in IFSS is usually accompanied by the decline in fracture toughness. Therefore, while there is a need for improving the fracture toughness or energy absorption in a composite material, the real need is to improve the energy absorption, but without sacrificing—and if possible, with a simultaneous improvement in—the strength of the composite material.

Mechanical interlocking between the fiber and the resin can significantly increase the impact performance (also known as toughness, fracture toughness, or energy absorption) of the composite while maintaining its structural integrity (also known as strength or tensile strength of the composite material). For example, hybrid sizing blends of compatible siloxanes (3-glycidopropyltrimethoxy silane) and incompatible siloxanes (tetraethoxysilane) with epoxy resin and silica nanoparticles increased surface roughness of the fiber. The increased surface roughness, in turn, increased mechanical interlocking between the fiber and the polymer matrix. Consequently, energy absorption improved.

While existing technologies use mechanical interlocking methods to improve the mechanical performance of composites (the twin properties of energy absorption and strength of a composite material), a chemical bonding method to improve this performance even better. Particularly, mechanical performance of composites is often limited by weak, brittle interfaces between fibers and composites. These weak interfaces are harmful in high performance applications such as aerospace, military, automotive, and sporting good applications. Thus, a need exists to improve the mechanical performance of the composite structure by means, such as chemical bonding methods, that are beyond the commonly employed methods such as the mechanical interlocking methods.

### SUMMARY OF INVENTION

This invention generally relates to the inclusion of rubbery-polymers, that is, rubbery homopolymers, rubbery block co-polymers or rubbery random copolymers in fiber sizing compositions. The rubbery homopolymers, rubbery block co-polymers, or the rubbery random copolymers are functionalized or non-functionalized. The rubbery-polymers in the fiber sizings chemically bond to the fiber and/or the polymeric matrix. This step improves the mechanical properties of the composite materials.

In one aspect, this invention relates to a process for improving the energy absorption and interfacial strength of composite materials, comprising contacting fibers with siloxane sizing solution, wherein said sizing solution comprises at least one rubbery-polymer.

In another aspect, this invention relates to a siloxane fiber sizing solution, comprising at least one rubbery-polymer.

This invention also relates to a composite material comprising fibers that are sized with siloxane fiber sizing solution, wherein said fiber sizing solution comprises at least one rubbery-polymer.

This invention also relates to glass fibers or carbon fibers coated with siloxane sizing solution, wherein said sizing solution comprises at least one rubbery-polymer. This invention also relates to a process for preparing an alkanolamine-modified rubbery random copolymer or block copolymer with rubbery-blocks, comprising, contacting

(i) said rubbery random copolymer; or
(ii) said block copolymer with rubbery-blocks; with
(iii) alkanolamine;
at elevated temperature in a basic media, wherein said alkanolamine is in molar excess,
wherein said alkanolamine ranges from C₁ to C₆ alkanolamine or mixtures thereof.

In yet another embodiment, this invention relates to an alkanolamine-modified rubbery random copolymer or block copolymer with rubbery-blocks.

### BRIEF DESCRIPTION OF THE DRAWINGS

Embodiments of the present invention will be described with reference to the accompanying drawings, wherein like reference numerals denote like parts, and in which:

FIG. 1 shows a representative force-displacement curve for the microdroplet test;

FIG. 2 shows FT-IR absorption spectra for (a) TES/GPS sizing; (b) TES/GPS/1a sizing; and (c) TES/GPS/1b sizing;

FIG. 3 shows IFSS (interfacial shear strength) and total energy absorption for Eglass/epoxy composites with TES/GPS, TES/GPS/1a and TES/GPS/1b sizing mixtures;

FIG. 4 shows SEM images of failure modes for E-glass/epoxy composites with (a) TES/GPS, (b) TES/GPS/1a, and (c) TES/GPS/1b sizing interphases;

FIG. 5 shows a representative load-displacement curve for the punch-shear test with distinct deformation regions: Initial Deformation, Compression Shear, Tension Shear, and Frictional Sliding;

FIG. 6 shows AFM images for:
(a) TES/GPS/SiO₂ sizing amplitude;
(b) TES/GPS/SiO₂ sizing phase;
(c) TES/GPS/SiO₂/1a sizing amplitude;
(d) TES/GPS/SiO₂/1a sizing phase;
(e) TES/GPS/SiO₂ cross-section analysis; and
(f) TES/GPS/SiO₂/1a cross-section analysis;

FIG. 7 shows IFSS and total energy absorption for E-glass/epoxy composites with the TES/GPS/SiO₂ sizing system;

FIG. 8 shows Punch-shear test load-displacement curves for E-glass/epoxy composites with TES/GPS/SiO₂ and TES/GPS/SiO₂/1a sizing mixtures;

FIG. 9 shows (a) Storage Modulus and (b) Loss Modulus sample temperature DMA curves for E-glass/epoxy composites with TES/GPS/SiO₂ and TES/GPS/SiO₂/1a sizing mixtures;

FIG. 10 shows SEM images of failures in microdroplet test for MSBM/MMAM sized E-glass/epoxy composites system;

FIG. 11 shows representative SEM images of SC-15/sized E-glass composite panels' cross-section;

FIG. 12 shows storage modulus of MMAM and MSBM-sized SC-15/E-glass composites;

FIG. 13 shows tan delta evaluation of MMAM and MSBM-sized SC-15/E-glass composites; and

FIG. 14 shows representative SEM image of SC-15/sized E-glass composite panel failure in punch shear test.

### DETAILED DESCRIPTION OF THE INVENTION

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are described herein. All references cited herein, including published or corresponding U.S. or foreign patent applications, issued U.S. or foreign patents, or any other references, are each incorporated by reference in their entireties, including all data, tables, figures, and text presented in the cited references. It is to be noted that the phrases “size composition,” “sizing composition,” “size,” and “sizing,” are used interchangeably herein.

In one embodiment, this invention relates to using rubbery-polymers (“RBPs”) as components in fiber sizing solutions. Addition of such RBPs to the sizing solution increases the energy absorption capacity of the matrix materials in the composite while retaining or even improving its tensile strength characteristic. The coiled configuration of rubbery-polymer may absorb a large amount of energy as the fiber begins to be pulled from the matrix, for example, in a fracture test. RBPs include functionalized or non-functionalized rubbery homopolymers, functionalized or non-functionalized rubbery random copolymers, and functionalized or non-functionalized rubbery block co-polymers comprising rubbery blocks as a component of a block copolymer.

When the rubbery polymer is a homopolymer, monomer choices for the polymer may include but are not limited to the families of methacrylic acid or acrylic acid and derivatives, and dienes. Specifically polybutadiene, polyisoprene, polybutyl acrylate, polymethoxyethyl acrylate, polyethylhexyl acrylate, polyethylene oxide, polyhexylene oxide, polyethylene propylene are examples of potential rubbery polymers.

When the rubbery polymer is a random copolymer, monomer choices may include but are not limited to the families of methacrylic acid or acrylic acid and derivatives, and dienes as the rubbery component. Specifically polybutadiene, polyisoprene, polybutyl acrylate, polyethylhexyl acrylate, polymethoxyethyl acrylate, polyethylene oxide, polyhexylene oxide, polyethylene propylene are examples of potential rubbery polymers. For the non-rubbery comonomer, monomer choices for the polymer may include but are not limited to the families of methacrylic acid or acrylic acid and derivatives, styrenics and dienes. Specific examples of the non-rubbery comonomer are methyl methacrylate, methylacrylate, styrene, silyl acrylates, caprolactam, acrylic acid, methacrylic acid, glycidyl methacrylate, hydroxyethyl acrylate, ethylene glycol methacrylate, methyl acrylamide, and dimethyl acrylamide.

When the rubbery-polymer is a functionalized homopolymer, a functionalized block copolymer, or a functionalized rubbery random copolymer, possible reactive functionalities may include but are not limited to siloxane, acid, hydroxyl, amine, anhydrides, isocyanates and glycidyl functionalities.

When the rubbery polymer is not a homopolymer or random copolymer, but comprises a rubbery-block as one block of a block copolymer, a general configuration of the RBP of the present invention can be written as follows:

-[A]ₙ-[B]ₘ-[C]ₚ-

In the above configuration, the block [B]ₘ is a rubbery-block. However, blocks [A]ₙ and [C]ₚ are not rubbery blocks.

We also note that the RBP can be a copolymer of only two blocks, that is the block component [A] can be the same as the block component [C] such as shown below:

-[A]ₙ-[B]ₘ-

In the above configuration, the block [B]ₘ is a rubbery-block while the block [A]ₙ is not a rubbery-block.

The above configuration does not necessarily mean that the RBPs of the present invention are either di-block or tri-block copolymers wherein at least one block is a rubbery block. For example, in yet another embodiment, the RBP can also be a copolymer of more than three blocks as shown below. This invention also includes those RBPs that may have more than one type of rubbery-block. Examples of these configurations, which are by no means restrictive—and if restrictive, only up to the extent that a person of ordinary skill in the art would be unaware of such compositions at the time of filing of the patent application—are given below. In these configurations the blocks [B]ₘ, [B¹]ₘ, and [B²]ₘ are rubbery-blocks.

-[A]ₙ-[B]ₘ-[C]ₚ-[B]ₘ-

-[A]ₙ-[B]ₘ-[C]ₚ-[B¹]_{q}-

-[A]ₙ-[B]ₘ-[B²]-[C]ₘ-

In one embodiment, the RBP comprises:
(a) some blocks—for example, blocks [A]ₙ and [C]ₚ in the above examples—that can compatibilize by reacting with the fiber and/or the resin or that exhibit similar chi parameters that provide excellent miscibility to the fiber and/or resin, and
(b) a second pure rubbery-block, for example blocks [B]ₘ, [B¹]_{q}, and [B²]ᵣ.

The first block of the RBP helps to increase or retain the tensile strength of the composite material. The second rubbery-block helps improve the energy absorption property of the composite material.

Examples of such RBPs include the Nanostrength® block copolymer products from Arkema, Inc (Philadelphia, Pa.), for example, styrene-butadiene-methyl methacrylate (SBM) and methyl methacrylate-butyl acrylate-methyl methacrylate (MAM), which are tri-block copolymers. In these configurations, the butadiene and the butyl acrylate blocks are rubbery-blocks. The styrene block, or the methyl methacrylate block are not rubbery-blocks. Other representative examples of RBPs include butadiene-dimethylsiloxane, butadiene-styrene, butadiene-caprolactam, where butadiene block represents a rubbery segment of the polymer. The use of RBP as a component in the sizing solution of fibers for thermoset or thermoplastic composites can greatly increase the energy absorption of composite materials.

The choice of monomers for blocks [A], and [C]ₚ may include but is not limited to the families of methacrylic acid or acrylic acid and derivatives, styrenics, and dienes. Specific examples of polymers used for blocks A and C are polymethyl methacrylate, polymethyl acrylate, polystyrene, polysilyl acrylates, polycaprolactam, polyacrylic acid, polymethacrylic acid, polyglycidyl methacrylate, polyhydroxyethyl acrylate, polyethylene glycol methacrylate, polymethyl acrylamide, and polydimethyl acrylamide.

The choice of monomers for blocks represented by [B]ₘ, [B¹]_{q}, or [B²]ᵣ may include but is not limited to the families of methacrylic acid or acrylic acid and derivatives, and dienes. Specifically polybutadiene, polyisoprene, polybutyl acrylate, polymethoxyethyl acrylate, polyethylhexyl acrylate, polyethylene oxide, polyhexylene oxide, polyethylene propylene are examples of potential rubbery blocks for blocks represented by [B]ₘ, [B¹]_{q}, or [B²]ᵣ.

When the rubbery polymer is a functionalized block copolymer, possible reactive functionalities which may be incorporated in either block include but are not limited to siloxane, acid, hydroxyl, amine, anhydrides, isocyanates and glycidyl functionalities.

Rubbery-polymers may be useful in sizing solutions for preparing a wide variety of thermoset resins (epoxies, unsaturated polyester, vinyl ester, polyurethanes, bismaleimides) and thermoplastic resins and with either glass fibers or carbon-based fibers such as carbon nanotubes.

In one embodiment, the non-rubbery block in the RBP makes the RBP water-soluble. The water-soluble RBPs of the present invention are therefore compatible with current sizing technologies that use sizing solutions. The RBPs can also be chemically-modified to achieve the solubility. The chemically-modified RBPs can then be added to the sizing solution. The RBPs may have additional advantages in energy absorption if they are functionalized with groups that can react to the fiber surface or to the polymeric resin (thermoset or thermoplastic). For example, to estimate the possibility of SBM and MAM tri-block co-polymers to serve as sizing components they were chemically-modified by reacting with excess of ethanolamine in tetrahydrofuran under reflux with 5-10 mol % of NaH as shown on Scheme 1 below.

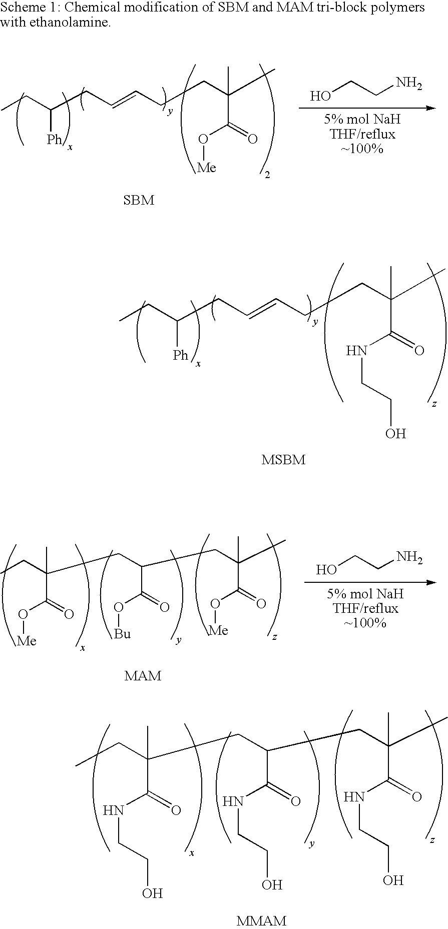

For example, the MSBM [modified poly(styrene-butadiene-methyl methacrylate)] triblock copolymer and MMAM [modified polymethyl methacrylate-butyl acrylate-methyl methacrylate)] RBPs described above are soluble in aqueous tetrahydrofuran, which allows them to be used as a sizing component for example, for E-glass fibers. In a typical sizing protocol, either polymer can be combined with a mixture of tetraethoxysilane/3-glycidoxypropyltrimethoxy silane in acidified aqueous tetrahydrofuran, followed by addition of E-glass fibers.

The present invention generally is applicable to thermoset matrix materials for composites. However, thermoplastic matrix materials for composites can also be used with the sizings of the present invention. Thermoset materials and thermoplastic materials used for composites are well-known in the art.

In one embodiment, hard inorganic materials such as silica nanoparticles or carbon nanotubes are also included in the sizing solution in addition to the RBPs. Particularly preferred carbon nanotubes include multi-walled carbon nanotubes. Other preferred nanoparticles include fumed silica, quartz, fullerenes, boron nitride, titania, zirconia, montmorillonite, wollastonite, nanoclays, silica gel, fused silica, alumina, kieselguhr, diatomaceous earth, bentonite, and their mixtures.

The sizing solution that can be used in the present invention can be an aqueous system or a non-aqueous system. It is generally know in the art that a system of miscible solvents with greater 50 percent of water content defines an aqueous system. On the other hand, a water concentration of less than 50 percent defines a the non-aqueous system. Examples of non-aqueous systems include solvents such as ketones, alcohols, and acetates and mixtures thereof—for example, lower ketones, alcohols, and acetates and mixtures thereof. More specifically, non-aqueous systems include examples such as toluene, methyl ethyl ketone (MEK), acetone, tetrahydrofuran (THF), dimethylformamide (DMF), ethanol, methanol, ethyl acetate, hexanol, benzene, dichloromethane (DCM), dimethylsulfoxide (DMSO).

The sizing solution also comprises suitable silane coupling agents. Silane coupling agents which may be used in the present size composition may be characterized by the functional groups amino, epoxy, azido, vinyl, methacryloxy, ureido, and isocyanato. In addition, the coupling agents may include an acrylyl or methacrylyl group linked through non-hydrolyzable bonds to a silicon atom of the silane.

Coupling agents for use in the sizing solution include monosilanes containing the structure Si(OR)₂, where R is an organic group such as an alkyl group. Lower alkyl groups such as methyl, ethyl, and isopropyl are preferred. Silane coupling agents enhance the adhesion of the sizing agent to the fibers, for example, glass fibers and to reduce the level of fuzz, or broken fiber filaments, during subsequent processing. Examples of suitable aminosilane coupling agents for use in the silane package include, but are not limited to aminopropyltriethoxysilane, N-β-aminoethyl-g-amino propyltrimethoxysilane, N-phenyl-γ-aminopropyltrimethoxysilane, and bis-γ-trimethoxy silylpropylamine.

Non-limiting examples of suitable epoxy silane coupling agents include tetraethoxysilane, a glycidoxy polymethylenetrialkoxysilane such as 3-glycidoxy-1-propyl-trimethoxysilane, an acryloxy or methacrylyloxypolymethylenetrialkoysilane such as 3-methacrylyloxy-1-propyl trimethoxysilane, γ-glycidoxypropyltrimethoxysilane, γ-methacryloxypropyl trimethoxysilane, α-chloropropyltrimethoxysilane, α-glycidoxypropylmethyldiethoxysilane, and vinyl-tris-(2-methoxyethoxy)silane. In at least one preferred embodiment, the epoxy silane coupling agent is γ-glycidoxypropyltrimethoxysilane. In another preferred embodiment, the silane coupling agent is a mixture of 3-glycidoxy-1-propyl-trimethoxysilane and tetraethoxysilane.

Additionally, the sizing composition optionally contains one non-ionic lubricant. Especially suitable examples of non-ionic lubricants include polyethylene glycol (“PEG”) 200 monolaurate and PEG 600 monooleate. Other non-limiting examples include a polyalkylene glycol fatty acid such as PEG 600 monostearate, PEG 400 monostearate, PEG 400 monooleate, and PEG 600 monolaurate. In a most preferred embodiment, the non-ionic lubricant is PEG 200 monolaurate.

In addition to the non-ionic lubricant, the sizing composition optionally contains one or more cationic lubricant and one or more antistatic agent. The cationic lubricant reduces interfilament abrasion. Suitable examples of cationic lubricants include, but are not limited to, polyethyleneimine polyamide salt and stearic ethanolamide. Anti-static agents especially suitable for use herein include antistatic agents that are soluble in the sizing composition. Examples of suitable antistatic agents include compounds such as quaternary ammonium antistatic agents, tetraethylammonium chloride, and lithium chloride.

### Experimental

For the experiments of the present invention, two systems of RBPs in sizing solutions were examined. The first system included two standard molecules with the polysiloxane sizing agents: hydroxyl-terminated polybutadiene 1a and hydroxyl-terminated polybutadiene/epoxy 1b (Scheme 2). The second system included chemically-modified styrene-butadiene-methyl methacrylate and chemically-modified methyl methacrylate-butyl acrylate-methyl methacrylate RBPs.

### First System

### (I) General Procedure

As a model composite system E-glass fiber/epoxy resin composite was chosen.

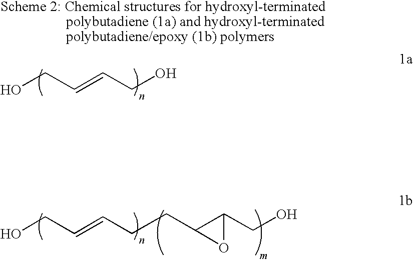

Both polymers 1a and 1b have low T_{g} (less than negative 90° C.) and belong to the class of liquid rubbers. Moreover, functional hydroxyl end-groups would allow for chemical bonding between the polymer molecule and E-glass fiber surface. No additional fiber surface treatment was needed. Polymer 1a represented a liquid rubber incompatible with epoxy matrix, whereas 1b, being randomly epoxidized co-polymer of butadiene, has segments compatible with epoxy matrix.

These experiments demonstrate the effect of low-T_{g} polybutadiene-based polymers as components of polysiloxane sizing on energy absorption and strength in E-glass fibers/epoxy composites. The polysiloxane sizing agents used were the glycidopropyltrimethoxy silane/tetraethoxysilane (GPS/TES) system. Particularly, the strength and energy absorption of pure GPS/TES polysiloxane sizing was compared with the GPS/TES/1a and the GPS/TES/1b system. The precise polysiloxane sizing composition and morphology were investigated to establish sizing composition/mechanical properties relationship in an E-glass/epoxy composite.

### (A) Materials and Preparations

The following items were purchased from Aldrich Chemical Co. (Milwaukee, Wis.) and were used as supplied:

### Solvents

(1) tetrahydrofuran THF; and
(2) deionized water.

### Reagents

### (1) Tetraethoxysilane TES;

(2) 3-glycidopropyltrimethoxy silane GPS;
(3) acetone;
(4) glacial acetic acid;
(5) hydroxyl functionalized polybutadiene (Mₙ=1,200);
(6) hydroxyl functionalized polybutadiene/epoxy (Mₙ=1,300; epoxy equivalent weight˜260)

The Amicure PACM [bis(4,4′-aminocyclohexyl)methane] curing agent was purchased from Air Products and Chemicals, Inc. (Allentown, Pa.) and was used as received.

The D.E.R. 353 Epoxy Bisphenol A Resin was purchased from DOW Chemical Company (Midland, Mich.) and was used as received.

The E-glass fibers were purchased from Owens-Corning Fiberglas Corporation (Toledo, Ohio) and were rinsed with acetone prior to sizing procedure.

Infrared spectra were recorded on a Nicolet Magna-860 Fourier Transform spectrometer (4 cm⁻¹ resolution) using KBr discs. All spectra were recorded at ambient temperatures.

Microscopy studies were carried out on the following instruments:

(1) Optical microscopy—Nikon Eclipse LV100 optical microscope; and
(2) SEM microscopy—TM 1000 electron microscope.

The E-glass fibers were de-sized using Sonics Vibra Cell ultrasonic tip.

The Microdroplet tests were performed on Newport 340RC apparatus using LabView 7.0 software.

### (B) Sizing of E-Glass Fiber

2 mL (9 mmol) of TES, 2 mL (9 mmol) of GPS, and 1 g of either 1a or 1b (where applicable) were pre-dissolved in about 5 mL of THF. The pre-dissolved mixture was then suspended in 60 mL, 1:2 THF/water solution with a catalytic amount of glacial acetic acid. The contents were stirred at ambient temperature for 30 minutes. After that, a tow of E-glass fibers was immersed into the sizing mixture for 15 minutes at ambient temperature. The supernatant solution was decanted off. The sized E-glass fibers were heated at 90° C. for two hours to achieve cross-linking of the polysiloxane interphase.

### (C) The Microdroplet Test

D.E.R. 353 low-viscosity epoxy resin (0.10 g) was mixed with Amicure PACM curing agent (0.018 g). Microdroplets with a length range between 150 μm to 250 μm were mounted on a single E-glass filament with an applicator. Microdroplets were left at ambient temperature to cure overnight, and then were heated in oven at 80° C. for two hours and 175° C. for additional two hours for a post-cure cycle. After the droplets were cured, they were attached to the sample holders, whereupon the droplet length, fiber diameter, and free fiber length were measured using an optical microscope. The samples were then tested using the microdroplet testing apparatus following the standard protocol (See Gao, X.; Jensen, R. E.; Li, W.; Deitzel, J. M.; McKnight, S. H.; Gillespie, J. W., Jr., J. Composite Mater., 42, 513, 2008; incorporated by reference herein). Five specimens were tested for each sample to acquire data for statistical analysis.

### (D) Microdroplet Test Data Reduction

Microdroplet test data reduction was performed according to the previously described method. IFSS was calculated using Equation 1:

IFSS=F_{c}/A, (1)

where:

A=π·d_{f}·lₑ,

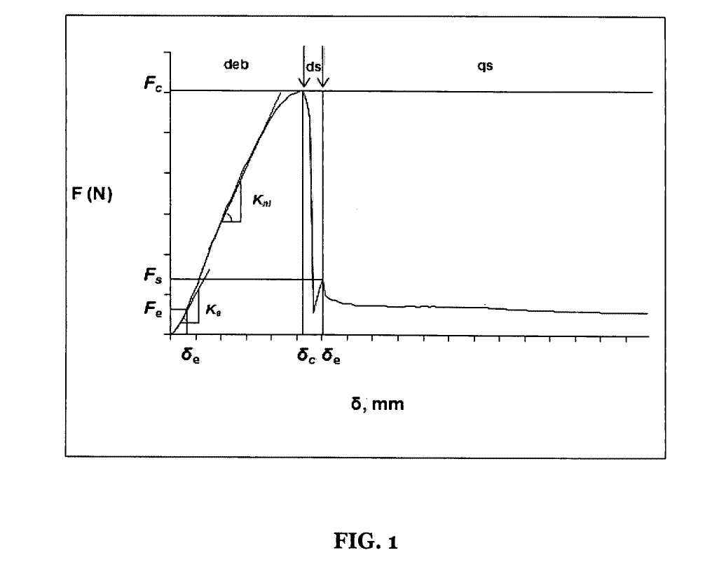

From FIG. 1, F_{c} is the maximum force of the load-displacement curve, d_{f} is the fiber diameter and lₑ is the embedded resin drop length. Energy absorption was divided into three regions (debonding, dynamic sliding, and quasi static sliding) according to the different failure modes (See FIG. 1):

Debonding Region (deb): 0≦δ≦δ_{c};
Dynamic Sliding Region (ds): δ_{c}<δ≦δₛ; and
Quasi Static Sliding Region (qs): δₛ<δ≦δₛ+lₑ.

Total energy (Eₜ) and elastic energy (Eₑ) for a specific region were calculated by Equations 2 and 3, respectively. Energy absorption (Eₐ) was calculated as a difference between Eₜ and Eₑ according to Equation 4 (See Gama, B. A.; Gillespie, J. W., Jr. Composite Structures 2008, 86, 356 for full description; incorporated by reference herein).

Eₜ(δ)=∫_{δ1}^{δ2}F(δ)dδ (2)

Eₑ(δ)=F(δ)²/2·K(δ)′ (3)

where:

K(δ)−Kₛ(δ)(δ≦δₑ);

K(δ)=Kₛ−α·(Kₛ−Kₙₗ)·(δ−δₑ)/δ(δ>δₑ)

E_{c}(δ)=Eₜ(δ)−Eₑ(δ) (4)

The specific energy absorption due to specific failure modes (E_{mechanism}^{sp}) was defined by Equations 5-7:

E_{deb}^{sp}=E_{G,deb}/A (5)

E_{ds}^{sp}=E_{a,ds}/(ΔL_{f}+Δδ_{f})·A (6) and

E_{cs}^{sp}=E_{a,qs}/l_{a,qs}·A (7)

where parameters ΔL_{f} and Δδ_{f} correspond to fiber stretching length and displacement change when the force drops from F_{c} to Fₛ (FIG. 1) in the dynamic sliding region.

### (E) E-Glass Fiber De-Sizing

Sized E-glass fiber was immersed into acetone (200 mL) and treated with a 5 s ultrasound pulse for 7 h at ambient temperature. The solution was decanted off the fiber, stripped to dryness, and analyzed by FT-IR spectroscopy.

### (II) Results and Discussion

### (A) E-Glass Fiber Sizing and Interphase Chemical Analysis

The general sizing mechanism of E-glass fibers with TES/GPS, TES/GPS/1a (or 1b) is presented on Scheme 3.

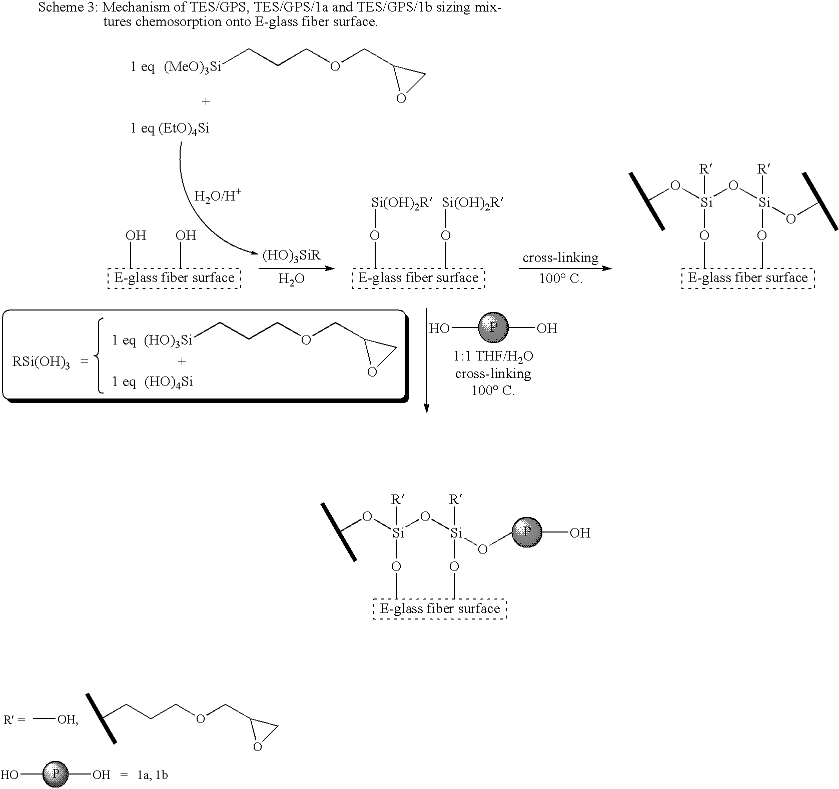

The first stage involved acid-catalyzed hydrolysis of labile RO—Si (R=Me, Et) group of a siloxane precursor to HO—Si moiety. Such intermediates further condensed with the E-glass fiber surface hydroxyl groups to form Si_{surface}—O—Si_{sizing}, chemically-bonded, interphase layer. The polymers 1a/1b also linked to the fiber surface/siloxane sizing by similar mechanism (Scheme 3) forming Si—O—C_{polymer} bridges. Further cross-linking in polysiloxane/1a (or 1b) sizing occurred at 100° C.

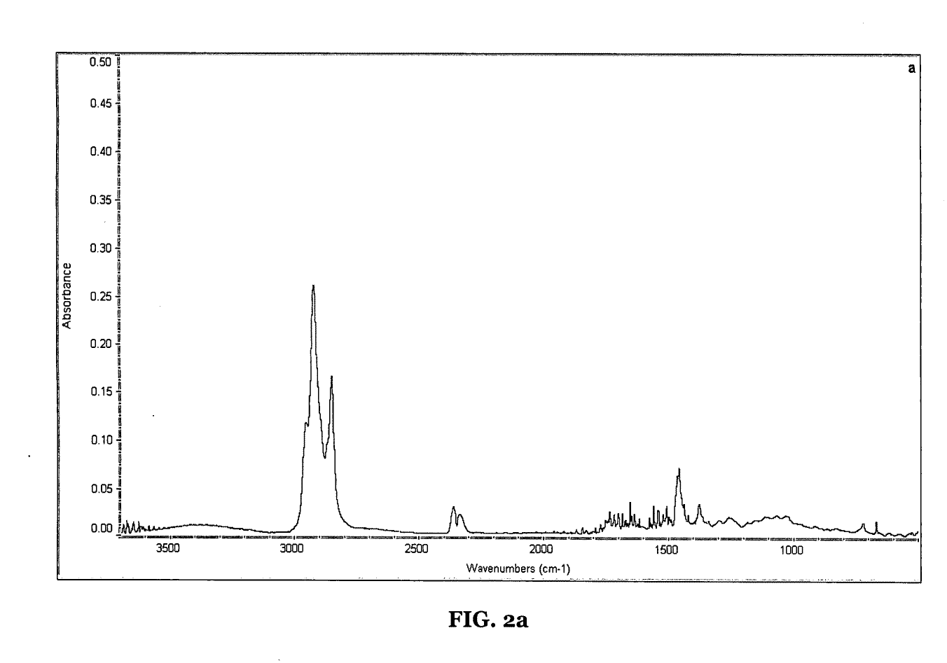

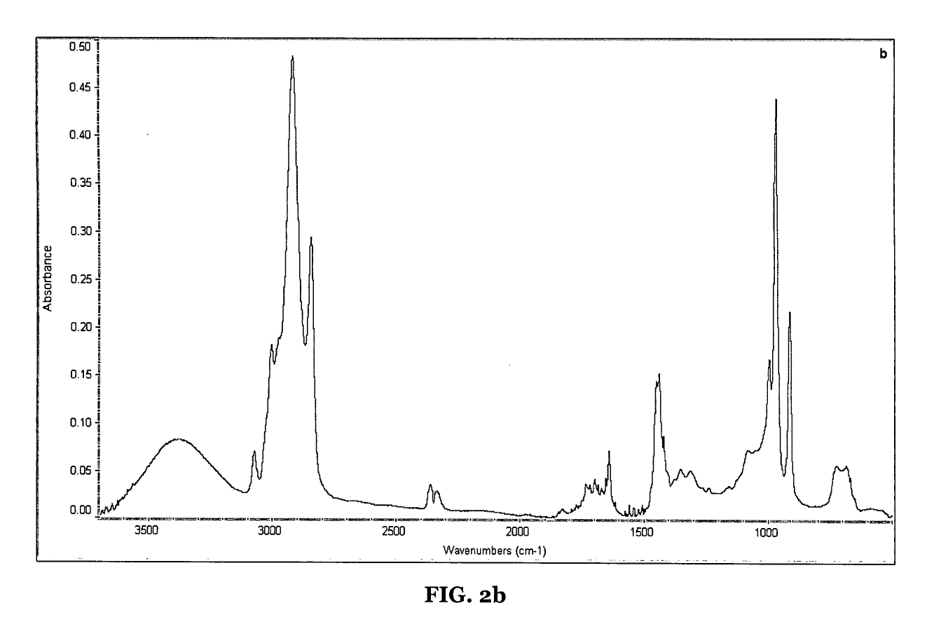

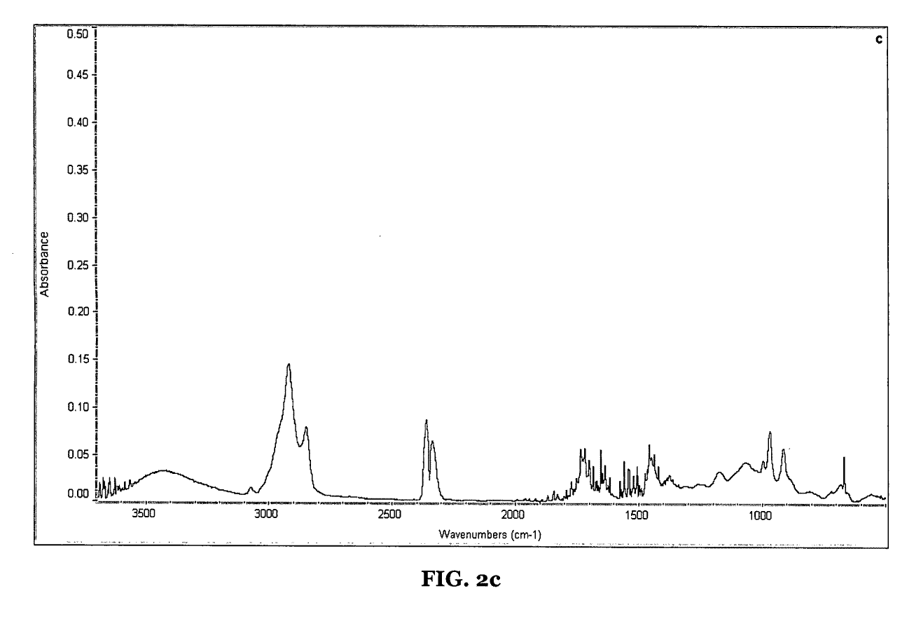

To confirm the sizing composition, the de-sizing of E-glass fibers was undertaken. Thus, sized fibers were treated with ultrasound in a presence of acetone as extracting solvent. Solutions were stripped to dryness, and the residue was analyzed by FT-IR (FIG. 2) spectroscopy techniques.

FT-IR spectroscopy confirmed the presence of siloxane Si—CH₂— stretch as a medium-intensity, double absorption at 2300-2400 cm⁻¹, and the free silanol groups as a broad band between 3200-3500 cm⁻¹. Also the absorptions of Si—O—Si and Si—O—C moieties were observed at the range 1030-1090 cm⁻¹ as medium/strong bands (FIGS. 2a-2c). Epoxy group in glycidoxypropyl siloxane in GPS/TES sizing was represented by very weak absorption at 909 cm⁻¹, almost at a threshold level. However, it grew into strong absorption stretch for TES/GPS/1a (916 cm⁻¹ and TES/GPS/1b (914 cm⁻¹) (C—O stretch, FIGS. 2a-2c), as well as presence of 1a and 1b as C═C double bond vibration at 1642 and 1646 cm⁻¹, respectively (FIGS. 2b and 2c).

### (B) IFSS, Energy Absorption, and Composite Failure Modes Evaluation

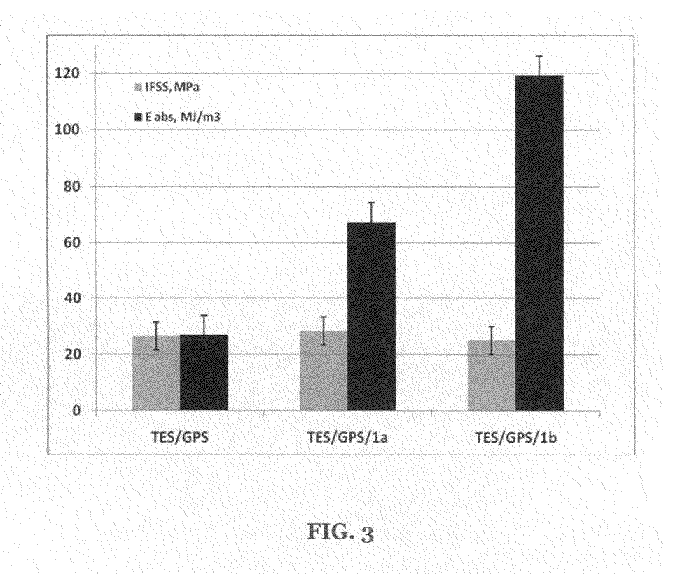

Microdroplet test techniques were selected as a primary choice for IFSS and energy absorption evaluation. The results for TES/GPS, TES/GPS/1a and TES/GPS/1b sizings are summarized in the FIG. 3 and Table 1, wherein energy absorption values correspond to the total energy absorption at debonding, dynamic and quasi static sliding regions.

TABLE 1
IFSS and energy absorption data for E-glass/epoxy composites
with TES/GPS, TES/GPS/1a and TES/GPS/1b sizing mixtures

| | IFSS, | E_{dsb}^{sp}, | E_{ds}^{sp}, | E_{qs}^{sp}, |
|---|---|---|---|---|
| Sample | MPa | kJ/m² | MJ/m³ | MJ/m³ |
| GPS/TES | 26.52 ± 2.85 | 1.20 ± 0.41 | 16.52 ± 2.56 | 3.52 ± 0.77 |
| GPS/TES/1a | 28.39 ± 2.90 | 1.13 ± 0.37 | 57.25 ± 5.29 | 3.91 ± 0.84 |
| GPS/TES/1b | 25.10 ± 3.01 | 1.11 ± 0.49 | 108.97 ± 8.46 | 3.98 ± 0.86 |

The data in FIG. 3 unambiguously show that whereas the change in IFSS values for TES/GPS, TES/GPS/1a and TES/GPS/1b sizing mixtures was statistically insignificant, there was a steady increase in total energy absorption moving from mixed siloxane sizing to TES/GPS/1a (polymer incompatible with epoxy resin) and further to TES/GPS/1b (polymer compatible with epoxy resin). Moreover, according to the data in Table 1, energy absorption increase came solely from dynamic sliding region (FIG. 1). While we are not beholden to the theoretical construct, we speculate that such effect of the polymer could be attributed to the random coil-type structure of the PBD rubbers, which straightened under the load absorbing additional energy. This effect should have been even more apparent for the polymer 1b, where the additional covalent chemical bonding exists between the epoxy/amine resin and epoxy domains of the polymer. However, in contrast to steep increase in energy absorption in the dynamic sliding region, the debonding energy absorption remained unchanged for all three samples regardless of degree of interphase/resin chemical bonding.

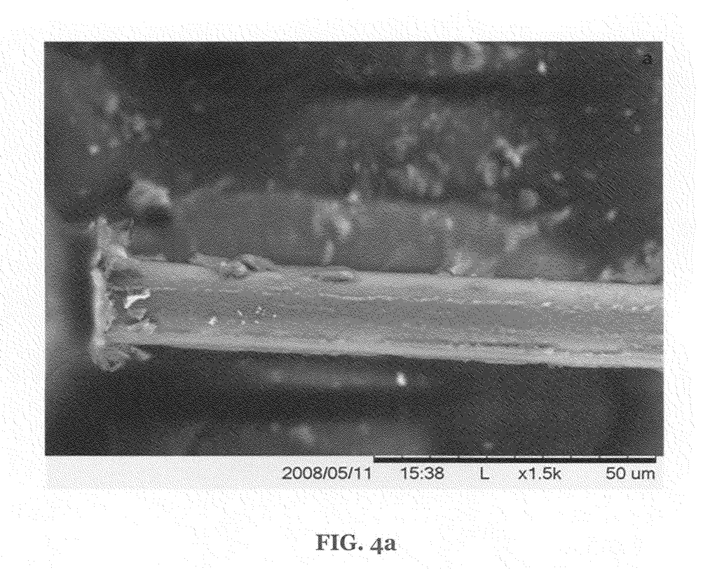

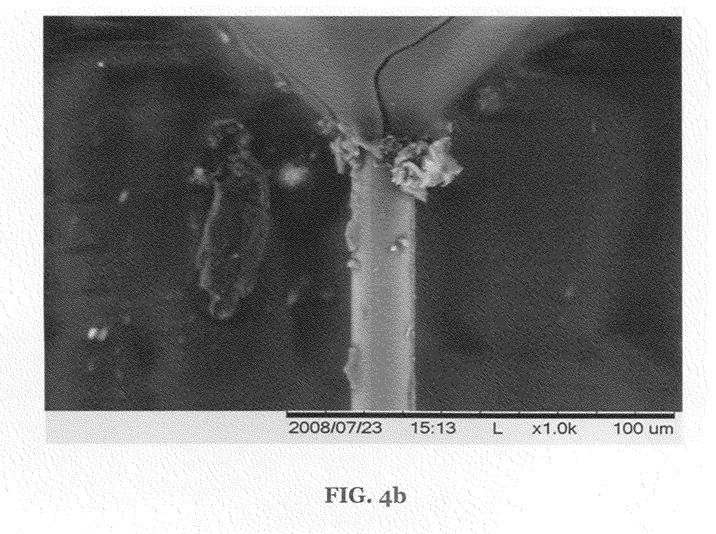

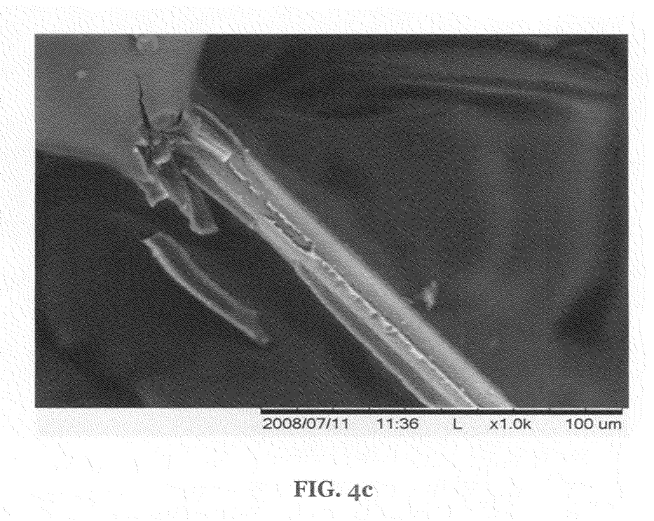

To explain such phenomenon the failure modes for TES/GPS, TES/GPS/1a and TES/GPS/1b sizing mixtures were examined with SEM imaging techniques (FIG. 4). As it becomes apparent from the review of SEM images, whereas TES/GPS sizing showed cohesive/adhesive failure at the fiber/resin interphase, both TES/GPS/1a, and TES/GPS/1b sizings exhibited additional failure in epoxy resin.

These experiments show the effect of low T_{g} polymers (such as 1a/1b) as components of polysiloxane sizing on strength and energy absorption of a composite material.

### Second System

### (I) General Procedure

The second sizing system evaluated the synergistic effect of hard (silica particles) in the polysiloxane-based sizing system on the mechanical performance of a composite material. More specifically, we evaluated the sizing system comprising TES/GPS/SiO₂ nanoparticles/1a and assessed the composite material made from the sized E-glass fibers. Particularly, we compared the strength and energy absorption of a polysiloxane sizing system comprising the TES/GPS/SiO₂ system with the TES/GPS/SiO₂/1a sizing system. We note that the TES/GPS/SiO₂ sizing system showed the highest combination of strength and energy absorption amongst the range of polysiloxane-only (no polybutadiene-based component such as 1a) sizings.

We investigated two aspects of the sizing system:
(1) siloxane sizing composition from a qualitative standpoint; and
(2) the morphology of the fiber surface to establish sizing composition/mechanical properties relationship in E-glass/epoxy composite.

### (A) Materials and Preparations

The following items were purchased from Aldrich Chemical Co. (Milwaukee, Wis.) and were used as supplied:

### Solvents

(1) tetrahydrofuran THF; and
(2) deionized water.

### Reagents

(1) Tetraethoxysilane TES;
(2) 3-glycidopropyltrimethoxy silane GPS;
(3) acetone;
(4) glacial acetic acid;
(5) hydroxyl functionalized polybutadiene (Mₙ=1,200);
(6) hydroxyl functionalized polybutadiene/epoxy (Mₙ=1,300; epoxy equivalent weight˜260)

The Amicure PACM [bis(4,4′-aminocyclohexyl)methane] curing agent was purchased from Air Products and Chemicals, Inc. (Allentown, Pa.) and was used as received. The D.E.R. 353 Epoxy Bisphenol A Resin was purchased from DOW Chemical Company (Midland, Mich.) and was used as received. The E-glass fibers were purchased from Owens-Corning Fiberglas Corporation (Toledo, Ohio) and were rinsed with acetone prior to sizing procedure.

The E-glass fibers were de-sized using Sonics Vibra Cell ultrasonic tip.

Infrared spectra were recorded on a Nicolet Magna-860 Fourier Transform spectrometer (4 cm⁻¹ resolution) using KBr discs. All spectra were recorded at ambient temperatures.

Punch shear tests were performed on Instron 4434 apparatus using Bluehill 2.0 software.

Dynamic Mechanical Analysis (DMA) tests were performed on Mettler-Toledo DMA861 instrument.

The Microdroplet tests were performed on Newport 340RC apparatus using LabView 7.0 software.

Microscopy studies were carried out on the following instruments:
(1) Optical microscopy—Nikon Eclipse LV100 optical microscope;
(2) SEM microscopy—TM 1000 electron microscope; and
(3) Surface morphology of sized fibers was studied by AFM microscopy on Veeco Dimension 3100 instrument in tapping mode.

### (B) Sizing of E-Glass Fabric

For preparing the fiber-sizing solution (without the 1a—hydroxyl-terminated polybutadiene), 10 ml of TES and 10 ml of GPS were mixed with 400 mL of deionized water in a 1-L Erlenmeyer flask. To this solution, 30 mL of 30% colloidal silica were added and the solution was magnetically stirred for 1 hour.

For preparing the TES/GPS/SiO₂/1a fiber-sizing solution, 3 g of the is polymer (hydroxyl-terminated polybutadiene) was weighed in a separate flask and dissolved in 400 mL of THF. It was then combined with aqueous siloxane sizing solution, and the resulting mixture was stirred for 30 min. The dissolving step was omitted for the TES/GPS/SiO₂ sizing.

The final sizing mixture was transferred into a bucket and diluted with 2,000 mL of 1:1 mixture of THF and deionized water. E-glass fabric sheets were cut into 2-inch×2-inch plies. Four 2-inch×2-inch E-glass fabric plies were completely immersed in fiber-sizing solution for 30 min. The fabric was removed from the solution, was initially dried at ambient temperature for 12 hours and subsequently was oven-dried at 210° F. for 12 additional hours.

### (C) Composite Manufacturing by Vacuum-Assisted Resin Transfer Molding

Epoxy SC-15 epoxy resin (Dow Chemical Co., Midland, Mich.) and curing agent were mixed in 100:37.5 ratio (by weight) and degassed under vacuum. Subsequently, composite panels were made by infusing the mixture into four plies of sized E-glass fiber sheets (fabric) using vacuum-assisted resin transfer molding (VARTM) technique. After infusion, the panels were cured inside an oven at 250° F. for 12 hrs. The E-glass/epoxy composite panels were then tested to determine and correlate the mechanical properties and morphology with sizing composition.

### (D) Physical Properties Measurements of Composite Panels

Selected physical properties of composite panels manufactured by the VARTM process are listed in the Table 2. Panel thickness was measured with a digital caliper, and the average of five measurements was recorded. Composite panel density was measured by weighing 1-inch×1-inch×1-inch cube in air and water and using the ASTM D792-98 dry/wet weight method.

Void content was measured according to ASTM D2734-70 standard.

Resin content was determined by weighing the cubic sample and the crucible together. The sample was incinerated in a furnace at 550° C. for 1 h in air. The crucible was cooled and weighed again. The resin content was calculated as a weight percent from available data. By comparing the actual and theoretical densities, void content was calculated as follows (Equations 1 and 2):

V=(T_{d}−M_{d})/T_{d} (8)

T_{d}=100/R/D+r/d) (9)

where:
V is the void content;
T_{d} is theoretical composite density;
M_{d} is measured composite density.
is resin weight percent in the composite;
D is resin density;
r is E-glass fiber percentage in composite; and
D is E-glass fiber density (2.54 g/cm³).

The fiber volume fraction was measured according to ASTM D 3171-76 standard according to Equation 10:

V_{f}%=(W×M_{d}/d×ω)×100 (10)

where:
V_{f} % is the fiber volume fraction;
W is weight of fiber in a composite;
ω is weight of a corresponding composite; and
d is E-glass fiber density (2.54 g/cm³).

Table 2 below lists selected physical properties of composite panels obtained with and without hydroxyl-terminated polybutadiene in a TES/GPS/silica system described supra.

TABLE 2
Physical properties data for E-glass/epoxy composites
with TES/GPS/SiO₂, and TES/GPS/1a sizing mixtures

| | Thickness, | Density, | Fiber Volume | Void |
|---|---|---|---|---|
| Sample | mm | g/cm³ | Fraction % | Content % |
| TES/GPS/ | 2.33 ± 0.12 | 1.91 ± 0.2 | 74.18 ± 0.85 | 1.25 ± 0.11 |
| SiO₂ | | | | |
| TES/GPS/ | 2.42 ± 0.23 | 1.87 ± 0.2 | 72.36 ± 0.85 | 1.17 ± 0.12 |
| SiO₂/1a | | | | |

### (E) Macromechanical Quasi-Static Punch Shear Test

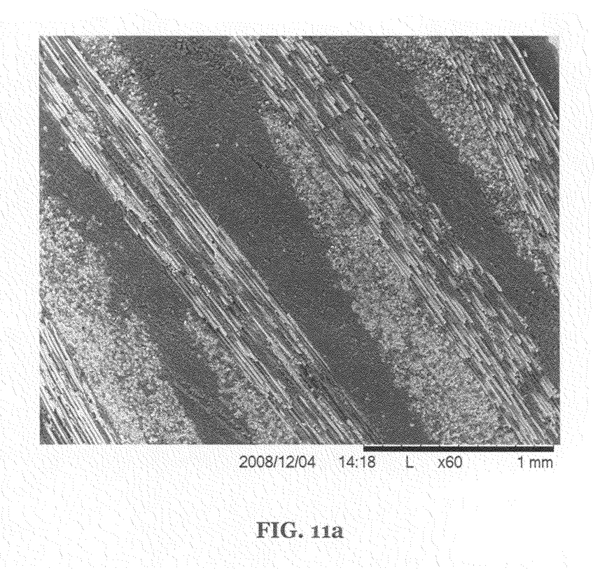

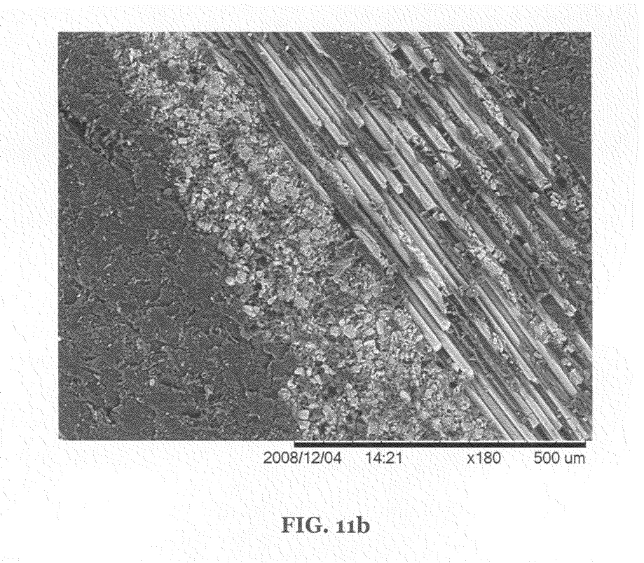

10-inch×10-inch panels were infused under the VARTM process using epoxy bisphenol A SC-15 resin (from Dow Chemical Co. Midland, Mich.) epoxy resin and sized E-glass fibers (4-plies layup). The representative SEM images of the panel's cross-sections are illustrated on FIG. 11. Physical properties of composite panels obtained are also listed in Table 3.

IFSS was calculated using Equation 11:

IFSS=Pₘₐₓ/A, (11)

where:

A=π·dₚ·lₑ,

Pₘₐₓ is the maximum load in the load-displacement curve as defined in FIG. 1;
dₚ is the punch diameter; and
lₑ is the thickness of a composite panel.

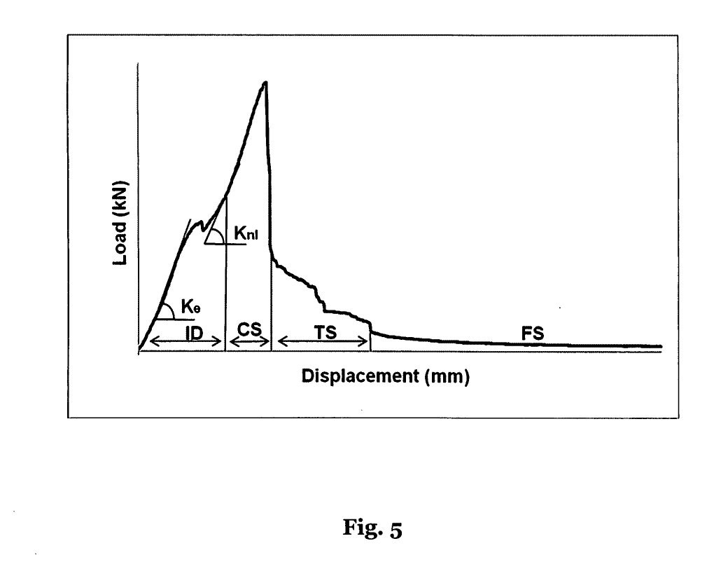

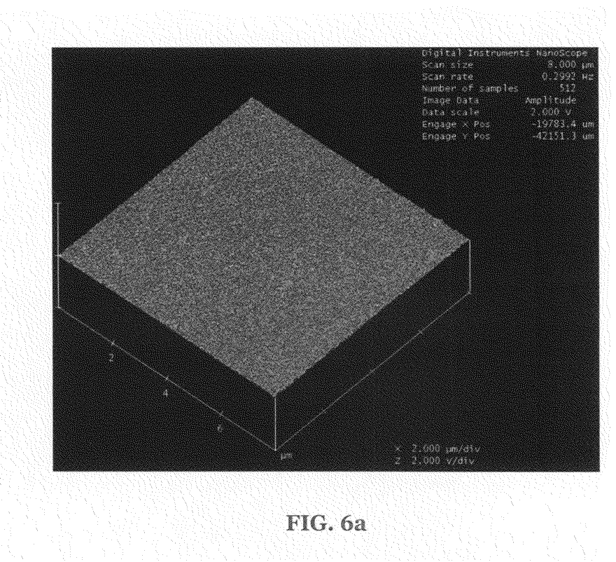

Energy absorption was divided into three regions: initial deformation (ID), compression shear (CS), and tension shear (TS), according to the different failure modes (FIG. 5). Total (Eₜ) and elastic (Eₑ) energies for a specific region were calculated by Equations 12 and 13, respectively. Energy absorption (Eₐ) was calculated as a difference between Eₜ and Eₑ according to Equation 14.

$$\begin{matrix}{E}_{t} ( δ ) = {\int }_{δ1}^{δ2} F ( δ ) d δ & ( 12 ) \\ {E}_{e} ( δ ) = {F ( δ )}^{2} / 2 \times K ( δ ) , & ( 13 ) \\ where \text{:} & \\ K ( δ ) = {K}_{e} ( δ ) ( δ \leq {δ}_{e} ) ; & \\ K ( δ ) = {K}_{e} - α \times ( {K}_{e} - {K}_{nl} ) \times ( δ - {δ}_{e} ) / δ ( δ > {δ}_{e} ) & \\ {E}_{e} ( δ ) = {E}_{t} ( δ ) - {E}_{e} ( δ ) & ( 14 )\end{matrix}$$

The specific energy absorption (E_{abs}^{sp}) is defined by Equation 15.

E_{abs}^{sp}=Eₐ/lₑ×ρ (15)

where:
Eₐ is the total energy absorption for the ID, CS and TS regions;
ρ is the density of a composite material; and
lₑ is the thickness of a composite panel.

### (F) Dynamic Mechanical Analysis

The composite panels were subjected to three-point bending test by DMA-861 in the range of 30-200° C. A force of 0.1 N was applied on composite panels with a heating rate of 2° C./min.

### (II) Results and Discussion

(A) E-Glass Fibers Sized with TES/GPS/SiO₂ and TES/GPS/SiO₂/1a Surface Morphology

Surface morphology of the sized fabric plays a pivotal role in controlling the interface properties of a corresponding composite material. Hence, the sized E-glass fabric was examined with Atomic Field Microscope (AFM).microscopy. The results of the study are shown in FIG. 6.

In contrast to the homogeneous surface of the siloxane-only sized fibers (FIGS. 6a and 6b), the PBD-containing sizing shows a distinct phase separation behavior on the fiber surface (FIGS. 6c and 6d). Thus, on the phase diagram (FIG. 6d) areas attributable to the rigid siloxane and soft is domains can be seen.

Cross-section surface analysis of the two sizings also confirmed the high degree of non-homogeneity and surface roughness for the sizing (FIGS. 6e and 6f). Based on prior studies and the comparison with the polysiloxane/silica-only sizing (FIGS. 6a and 6b), we tentatively assigned higher areas to the soft polymer-rich domains, whereas hard crystalline siloxane domains had a tendency to locate in the valleys between elevated surface areas. Due to such phase separation behavior the overall surface roughness for the 1a-containing sizing was higher than for the corresponding homogeneous polysiloxane-only sizing. Such increase in the surface roughness and formation of polymer-rich surface domains miscible with epoxy resin for the sizing compared to siloxane-only sizing have a profound effect on the mechanical properties of a corresponding composite material, which is discussed below.

### (B) IFSS, Energy Absorption, and Dynamic Modulus Evaluation

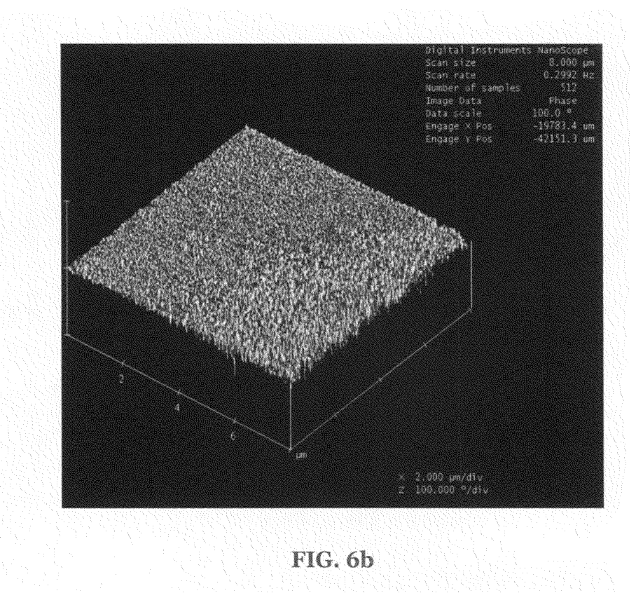

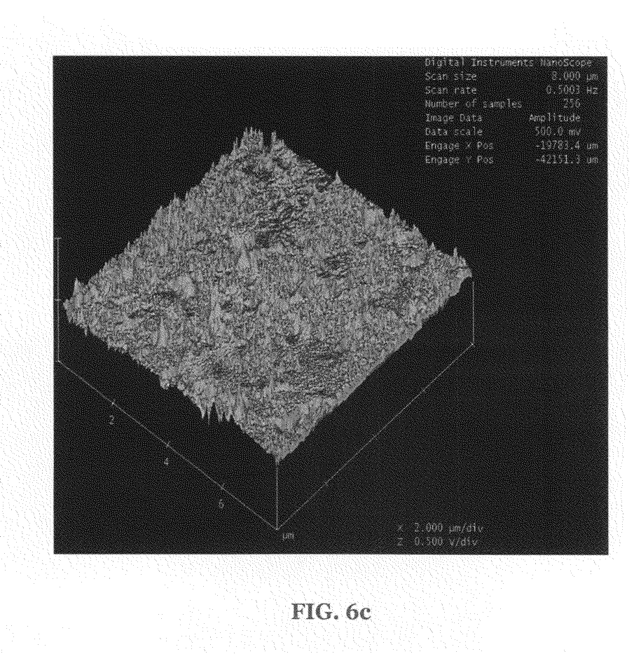

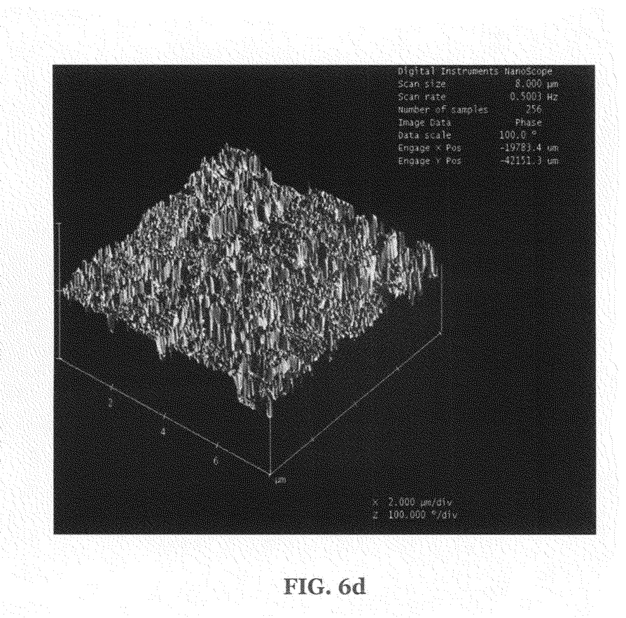

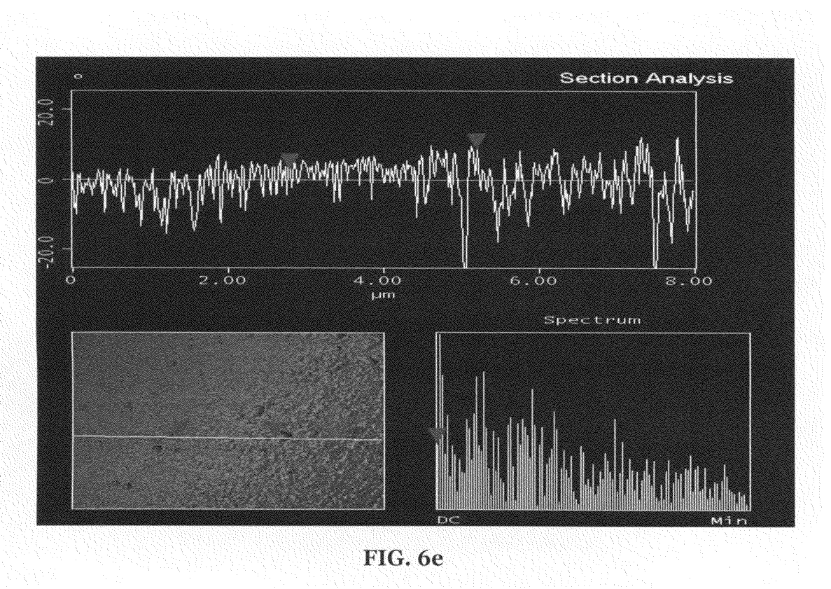

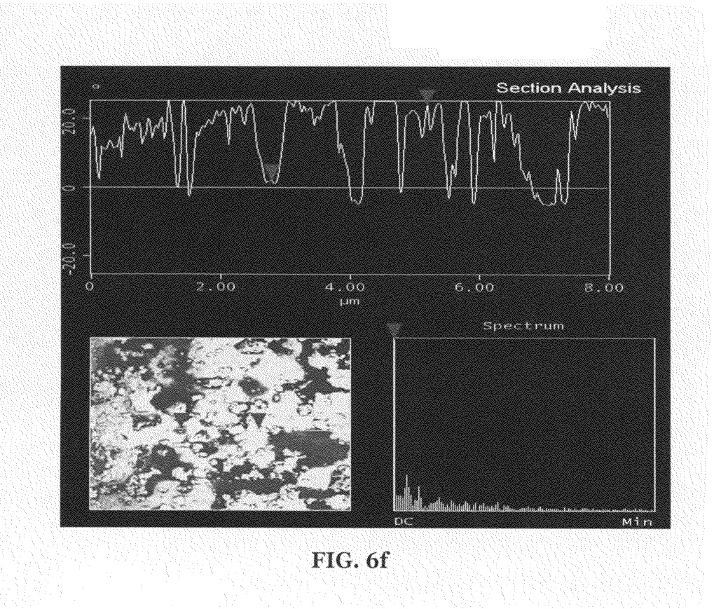

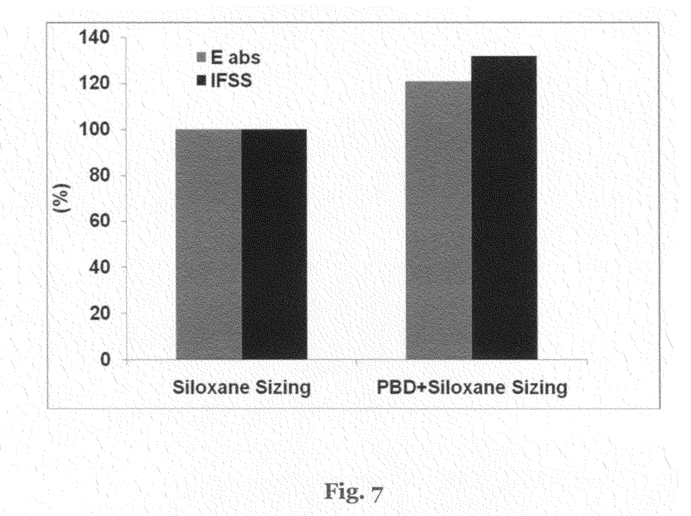

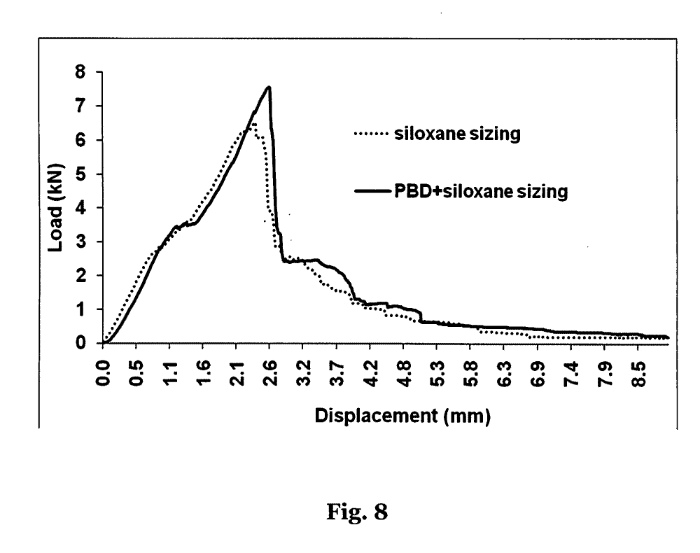

Macromechanical punch shear test technique was used to estimate IFSS and energy absorption in composite materials. The results for TES/GPS/SiO₂ and TES/GPS/SiO₂/1a sizings are summarized on FIGS. 7 and 8. [energy absorption values correspond to the total energy absorption at initial deformation (ID), compression shear (CS) and tension shear (TS) regions normalized by the shear volume] and Table 3.

TABLE 3
IFSS and energy absorption data for E-glass/epoxy composites
with TES/GPS/SiO₂, and TES/GPS/1a sizing mixtures

| | IFSS, | IFSS, | E_{abs}^{sp}, | E_{abs}^{sp}, |
|---|---|---|---|---|
| Sample | MPa | % | kJ × m²/kg | % |
| TES/GPS/ | 76.79 ± 3.89 | 100 | 31.41 ± 2.94 | 100 |
| SiO₂ | | | | |
| TES/GPS/ | 101.27 ± 2.74 | 132 | 39.18 ± 3.02 | 121 |
| SiO₂/1a | | | | |

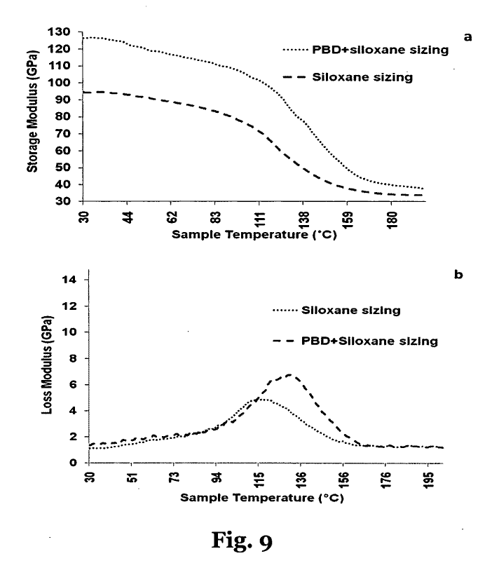

The data in FIG. 7 and Table 3 show that when one adds rubbery polymer to the fiber sizing, both the IFSS, as well as energy absorption increase by 32% and 19%, respectively. Moreover, analysis of the load-displacement curves (FIG. 8) demonstrates that the energy absorption increase came from both CS and the TS regions. While we do not necessarily subscribe that the following theory is the only explanation, we speculate that such effect of the polymer could be attributed to the significant deformation of rubber domains under the compressive shear load, resulting in energy absorption increase. Whereas the energy absorption increase at the CS region suggests that the rubbery domains undergo significant degree of deformation compared to rigid silica nanoparticles and siloxane sizing; the increase of energy absorption in the TS region can be attributed to the enhanced interface surface roughness, leading to higher frictional forces. Increased IFSS can be rationalized by both higher mechanical fiber-resin interlocking due to the higher interface roughness, and by increased miscibility of polymeric domains in epoxy resin, which also provides additional interface strength. The superior behavior of the 1a-containing sizing versus siloxane-only analog in E-Glass/epoxy composite was confirmed by a Dynamic Mechanical Analysis (DMA) test (FIG. 9).

Thus, in a 3-point bending test the composite with 1a-containing sizing exhibited 34% higher storage modulus (E′) in the glass region, as well as 23% higher modulus in the rubbery region (FIG. 11a). Such behavior indicates that, although by a smaller margin, the TES/GPS/SiO₂/1a sizing retains higher IFSS value even at elevated temperatures.

The analysis of the loss modulus (E′) behavior provides further insights into molecular motion of interface layer (FIG. 11b). First, the T_{g} for TES/GPS/SiO₂/1a sizing is 14° C. higher than for the composite with TES/GPS/SiO₂ only sizing (128° C. and 114° C., respectively). Since the loss modulus is a measure of dissipated energy or lost as heat per cycle of sinusoidal deformation, it is very sensitive to the change in molecular motions. Shift of T_{g} value to a higher temperature for TES/GPS/SiO₂/1a sizing indicates lower segmental motion at the fiber-resin interface because the interface surface roughness and fiber-resin adhesion have increased. Once again, the DMA studies demonstrate the synergistic behavior of hard silica and rubbery macromolecules as a part of polysiloxane sizing.

These experiments simulate the effect of the inclusion of low T_{g} polymers (such as 1a) as components of polysiloxane sizing on the strength and energy absorption of a composite material.

Thus, rubbery polymer such as is can be used as components for polysiloxane-based sizing for E-glass fibers/epoxy resin composites. While this invention is not predicated on any specific theoretical basis, we speculate that the E-glass fibers/epoxy resin composites form Si_{surface}—O—Si_{sizing} and Si—O—C_{polymer} robust covalent bridges with polysiloxane network, fiber surface and hydroxyl-terminated PBD polymer. The use of 1a as polysiloxane sizing component (TES/GPS/SiO₂/1a) considerably improves both the IFSS and energy absorption of a composite material compared to the hybrid TES/GPS/SiO₂ sizing. Moreover, the introduction of a rubbery polymer into the rigid polysiloxane sizing leads to 34% higher dynamic modulus in a glass region, as well as 23% higher modulus in rubbery region. As has been shown, the energy absorption rise comes from both compression shear and tension shear regions due to higher fiber-resin miscibility of polymer-containing surface domains and the resin, resulting in superior interface adhesion. Furthermore, the induced non-homogeneity of the fiber surface in the latter case leads to increased surface roughness, which can also yield higher energy absorption via elevated frictional forces at the tension shear region. Both factors—increased interfacial adhesion and mechanical fiber-resin interlocking resulting from the rougher surface roughness—contribute to a significant growth of IFSS.

### Third System

### (I) General Procedure

In order to evaluate SBM and MAM tri-block co-polymers as sizing components, they were first chemically-modified by reacting with excess of ethanolamine in THF under reflux with 10 mol % of NaH as shown previously in Scheme 1.

Because modified SBM (MSBM) and modified MAM (MMAM) polymers are soluble in aqueous THF (1a), it was possible to use these RBPs as sizing component for E-glass fibers. The impact of MSBM and MMAM polymers on strength and energy absorption in ballistic event were screened with microdroplet test techniques described previously. The values for Interfacial Shear Strength (IFSS), and specific (per unit of interphase) debonding (deb), dynamic sliding (ds) and quasi-static (qs) energy absorption as well as sizing conditions are summarized in Table 4-6. Reference data are given as Entries 5, 8 and 11.

### (II) Results and Discussion

TABLE 4
IFSS and energy absorption data for MSBM/MMAM sized E-glass/epoxy
composites estimated by microdroplet test techniques

| | | | E^{sp}_{deb}, | E^{sp}_{ds}, | E^{sp}_{qs}, |
|---|---|---|---|---|---|
| No. | Sizing Conditions | IFSS (MPa) | kJ/m² | MJ/m³ | MJ/m³ |
| 1. | MMAM with SiO₂ NP (1% wt)/ | 35.78 ± 4.2 | 0.89 ± 0.04 | 3.25 ± 1.2 | 39.25 ± 2.9 |
| | TES:GPS = 1:1 hydrolyzed and | | | | |
| | pre-heated @60° C./Epoxy resin | | | | |
| 2. | MSBM mixed separately with | 24.5 ± 2.0 | 0.44 ± 0.07 | 58.3 ± 3.1 | 8.86 ± 1.2 |
| | TES:GPS = 1:1/SiO₂ NP (1% wt) | | | | |
| | hydrolyzed and pre-heated | | | | |
| | @60° C./Epoxy resin | | | | |
| 3. | MMAM with SiO₂ NP (1% wt)/ | 68.67 ± 3.6 | 7.48 ± 1.42 | 25.70 ± 2.5 | 25.62 ± 2.7 |
| | TES:GPS = 1:1 hydrolyzed | | | | |
| | and pre-heated @60° C./Multi | | | | |
| | Wall Carbon Nanotubes pre- | | | | |
| | oxidized with H₂O₂/Epoxy resin | | | | |
| 4. | MSBM mixed separately with | 61.6 ± 3.6 | 1.38 ± 0.45 | 47.19 ± 3.2 | 2.95 ± 0.9 |
| | TES:GPS = 1:1/SiO₂ NP (1% wt) | | | | |
| | hydrolyzed and pre-heated | | | | |
| | @60° C./Multi Wall Carbon | | | | |
| | Nanotubes pre-oxidized with | | | | |
| | H₂O₂/Epoxy resin | | | | |
| 5. | Reference: TES:GPS = 1:1; | 52.30 ± 3.9 | 1.27 ± 0.8 | 73.06 ± 5.7 | 6.94 ± 2.2 |
| | SiO₂ Nanoparticles (20 nm) | | | | |
| | 1% wt/Epoxy resin | | | | |

Table 4 demonstrates how using rubbery block copolymers, particularly in the quasi-static region, improve energy absorption over an epoxy reference material. It also shows how using rubbery block copolymers in synergy with multiwall carbon nanotubes improves interfacial strength and energy absorption in the debonding region.

TABLE 5
IFSS and energy absorption data for MSBM/MMAM sized E-glass/polyurethane
composites estimated by microdroplet test techniques

| | | | E^{sp}_{deb}, | E^{sp}_{ds}, | E^{sp}_{qs}, |
|---|---|---|---|---|---|
| No. | Sizing Conditions | IFSS (MPa) | kJ/m² | MJ/m³ | MJ/m³ |
| 6. | MSBM mixed separately with | 32.98 ± 2.5 | 0.18 ± 0.02 | 57.21 ± 4.6 | 3.59 ± 0.8 |
| | TES:GPS = 1:1/SiO₂ NP (1% wt) | | | | |
| | hydrolyzed and pre-heated | | | | |
| | @60° C./Polyurethane resin | | | | |
| 7. | MMAM with SiO₂ NP (1% wt)/ | 18.12 ± 2.0 | 0.38 ± 0.12 | 14.98 ± 1.9 | 1.74 ± 0.6 |
| | TES:GPS = 1:1 hydrolyzed | | | | |
| | and pre-heated @60° C./ | | | | |
| | Polyurethane resin | | | | |
| 8. | Reference: TES:GPS = 1:1; | 11.38 ± 1.4 | 0.11 ± 0.02 | 6.08 ± 1.3 | 1.82 ± 0.6 |
| | SiO₂ Nanoparticles (20 nm) | | | | |
| | 1% wt/Polyurethane resin | | | | |

Table 5 demonstrates how using rubbery block copolymers improve both interfacial strength and energy absorption in all regions—debonding, dynamic sliding and quasi-static sliding—over a polyurethane reference material.

TABLE 6
IFSS and energy absorption data for MSBM/MMAM sized E-glass/vinyl
ester composites estimated by microdroplet test techniques

| | | | E^{sp}_{deb}, | E^{sp}_{ds}, | E^{sp}_{qs}, |
|---|---|---|---|---|---|
| No. | Sizing Conditions | IFSS (MPa) | kJ/m² | MJ/m³ | MJ/m³ |
| 9. | MSBM mixed separately with | 12.23 ± 2.1 | 0.11 ± 0.05 | 7.22 ± 1.3 | 0.36 ± 0.1 |
| | TES:GPS = 1:1/SiO₂ NP (1% wt) | | | | |
| | hydrolyzed and pre-heated | | | | |
| | @60° C./Vinyl Ester resin | | | | |
| 10. | MMAM with SiO₂ NP (1% wt)/ | 4.91 ± 1.1 | 0.01 ± 0.01 | 2.98 ± 1.0 | 0.54 ± 0.1 |
| | TES:GPS = 1:1 hydrolyzed | | | | |
| | and pre-heated @60° C./ | | | | |
| | Vinyl Ester resin | | | | |
| 11. | Reference: TES:GPS = 1:1; | 9.81 ± 1.0 | 0.20 ± 0.04 | 3.36 ± 0.9 | 0.58 ± 0.2 |
| | SiO₂ Nanoparticles (20 nm) | | | | |
| | 1% wt/Vinyl Ester resin | | | | |

Table 6 demonstrates how using rubbery block copolymers improves interfacial strength and energy absorption in the dynamic sliding region over a vinyl ester reference material.

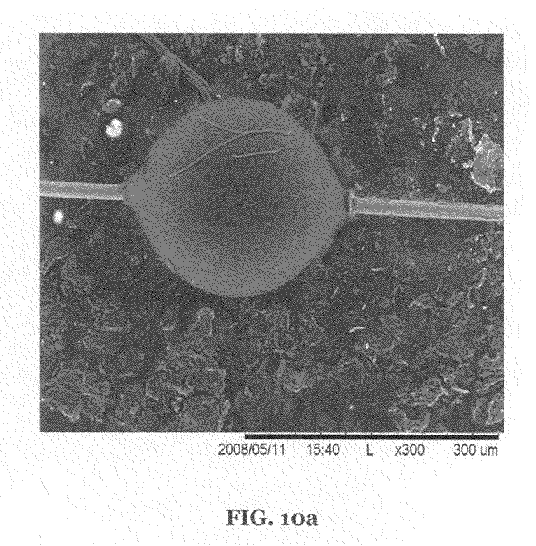

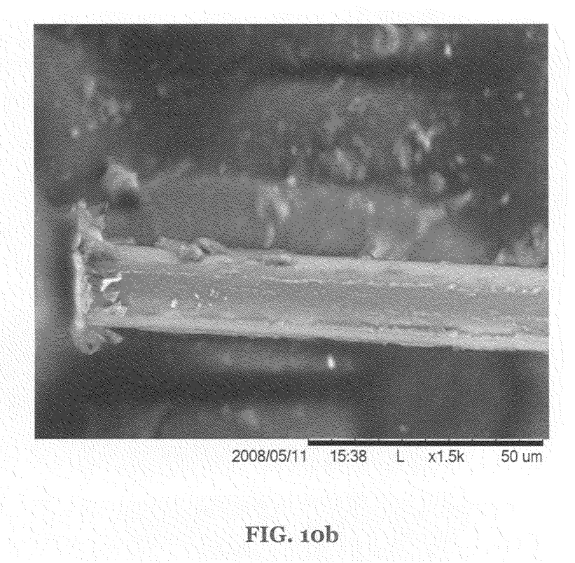

Failure analysis for the microdroplet tests was performed by SEM microscopy techniques. Typical SEM images are presented below showing mostly cohesive failure in the resin at the interphase (FIG. 10).

### (A) Macromechanical Punch-Shear Test

Sizing mixtures (Examples 7 & 8 in Table 4), which showed the best improvement for both IFSS and energy absorption values, were further selected for macromechanical punch shear tests. 10-inch×10-inch panels were infused under the VARTM process using epoxy bisphenol A SC-15 resin (from Dow Chemical Co. Midland, Mich.) epoxy resin and sized E-glass fibers (4-plies layup). The representative SEM images of the panel's cross-sections are illustrated on FIG. 11. Physical properties of composite panels obtained are also listed in Table 7.

TABLE 7
Physical properties for MMAM, MSBM,
and unsized composite panels

| Properties | MMAM | MSBM | TES/GPS/SiO₂ | Unsized |
|---|---|---|---|---|
| Thickness, mm | 3.6 ± 0.2 | 34 ± 0.2 | 3.2 ± 0.2 | 3.3 ± 0.2 |
| Density, g/cm³ | 1.93 ± 0.2 | 1.94 ± 0.2 | 1.90 ± 0.2 | 1.89 ± 0.2 |
| Fiber volume | 56.2 ± 2.4 | 57.8 ± 2.4 | 56.20 ± 2.7 | 55.7 ± 2.4 |
| fraction, % | | | | |
| Void content, % | 0.93 ± 0.1 | 0.89 ± 0.1 | 0.95 ± 0.1 | 1.07 ± 0.1 |

Macromechanical tests data obtained by punch-shear test techniques for selected MMAM and MSBM sizings as well as for unsized E-glass fabric and TES/GPS/SiO₂ nanoparticle hybrid polysiloxane sizing reflect microdroplet test results and are summarized in Table 8 below and FIG. 11.

TABLE 8
Strength and energy absorption data for sized and unsized E-glass/SC-15
epoxy resin composites (4 plies) by punch-shear test technique

| Example | | Strength, | E^{sp}_{ID}, | E^{sp}_{cs}, | E^{sp}ₜₛ, | E^{sp}ₜₒₜₐₗ, |
|---|---|---|---|---|---|---|
| No. | Sizing composition | MPa | MJ/m³ | MJ/m³ | MJ/m³ | MJ/m³ |
| 12. | MMAM with SiO₂ NP (1% wt)/ | 70.38 ± 2.14 | 21.83 ± 1.08 | 54.99 ± 2.70 | 71.51 ± 3.27 | 148.33 ± 5.20 |
| | TES:GPS = 1:1 hydrolyzed | | | | | |
| | and preheated @60° C./ | | | | | |
| | Epoxy resin | | | | | |
| 13. | MSBM mixed separately with | 56.76 ± 2.16 | 20.17 ± 1.08 | 66.42 ± 2.11 | 39.98 ± 1.31 | 126.57 ± 5.04 |
| | TES:GPS = 1:1/SiO₂ NP (1% wt) | | | | | |
| | hydrolyzed and pre-heated | | | | | |
| | @60° C./Epoxy resin | | | | | |
| 14. | Reference: unsized E-glass | 40.37 ± 1.56 | 25.95 ± 1.12 | 43.33 ± 1.95 | 8.93 ± 0.76 | 78.21 ± 2.87 |
| | fibers/Epoxy resin | | | | | |
| 15. | Reference: TES:GPS = 1:1; | 96.02 ± 2.81 | 20.4 ± 6.90 | 72.82 ± 7.58 | 23.4 ± 0.20 | 116.58 ± 4.90 |
| | SiO₂ Nanoparticles (20 nm) | | | | | |
| | 1% wt/Epoxy resin | | | | | |

The punch-shear macromechanical data unambiguously demonstrated that both MMAM and MSBM-based polysiloxane sizings lead to considerable improvement of energy absorption compared to TES/GPS sizing by 27.5% and 8.6%, respectively; however the material strength is below the reference values by 27.1% (MMAM) and 41.7% (MSBM).

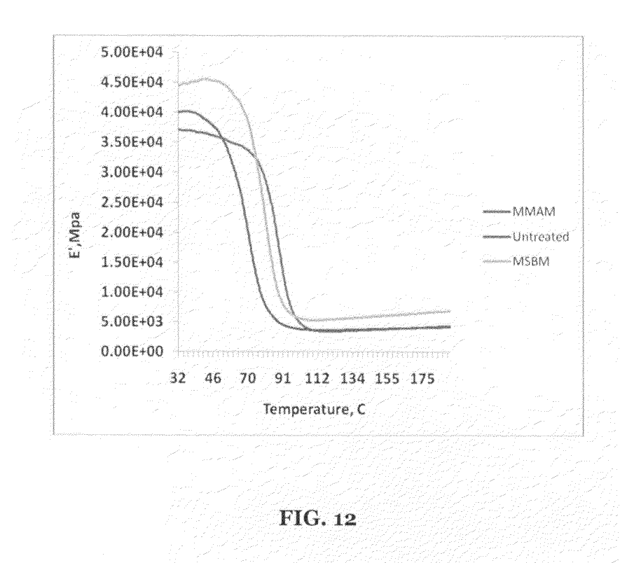

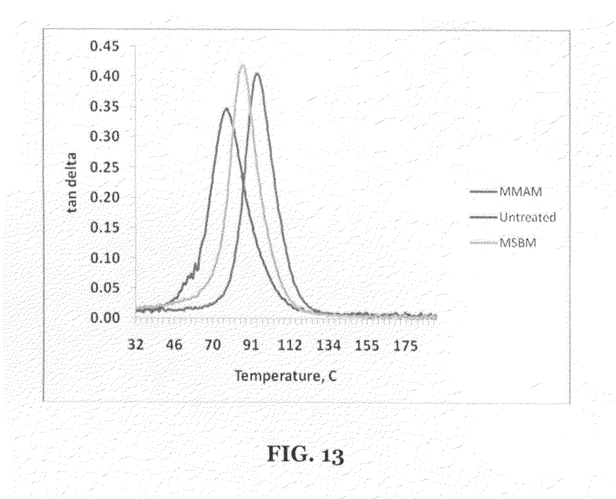

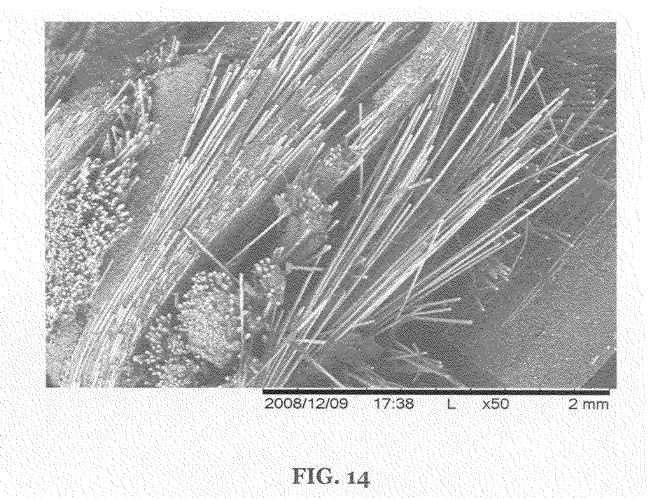

Modulus and tan delta parameters for MMAM and MSBM sized composites were evaluated by Dynamic Mechanical Analysis techniques in the temperature range 25-200° C. and compared to unsized sample. Results summarized in FIG. 12 show the MSBM sizing at the highest value of initial storage modulus for MSBM panel (44.2 GPa) versus 36.9 GPa for MMAM sizing and 40.0 GPa for unsized sample, whereas T_{g} values were at 86° C. (MSBM), 94° C. (MMAM), and 72° C. (unsized sample) (see FIG. 13). Also, in the rubbery region the MSBM sample exhibited a higher modulus (7.1 GPa) compared to about 5 GPa for MMAM and unsized samples. Energy damping values (tan delta) for MMAM and SBM sized composite panels were higher than for the unsized sample.

Failure modes of composite panels were examined by SEM microscopy (FIG. 9).

### ABBREVIATIONS

MSBM Modified poly(styrene-butadiene-methyl methacrylate)
MMAM Modified polymethyl methacrylate-butyl acrylate-methyl methacrylate);

### TES Tetraethoxysilane;

GPS 3-Glycidoxypropyltrimethoxy silane

### SEM Scanning Electron Microscopy

### RBP Rubbery-polymers

MAM Methyl methacrylate-butyl acrylate-methyl methacrylate
SBM Styrene-butadiene-methyl methacrylate
MEK Methyl ethyl ketone acetone

### THF Tetrahydrofuran

### DMF Dimethylformamide

### DCM Dichloromethane

### DMSO Dimethylsulfoxide

PEG Polyethylene glycol
IFSS Interfacial shear strength

### DMA Dynamic Mechanical Analysis

ID Initial deformation
CS Compression shear
TS Tension shear

### PBD Polybutadiene

VARTM Vacuum-assisted resin transfer molding

### NP Nanoparticles

MA Poly(methyl acrylic acid)

### DMA Poly(N,N-dimethylacrylamide)

FS Frictional sliding
AFM Atomic Field Microscopy

1. A process for improving the energy absorption and interfacial strength of composite materials, comprising contacting fibers with siloxane sizing solution, wherein said sizing solution comprises at least one rubbery-polymer.

2. The process as recited in claim 1, wherein said rubbery-polymer is selected from the group consisting of rubbery homopolymer, rubbery random copolymers, block copolymer with rubbery-blocks, functionalized rubbery homopolymer, functionalized rubbery random copolymers, functionalized block copolymer with rubbery-blocks, and mixtures thereof.

3. The process as recited in claim 1, wherein said rubbery-polymer is selected from the group consisting of styrene-butadiene-methyl methacrylate block copolymer, methyl methacrylate-butyl acrylate-methyl methacrylate block copolymer, ethanolamine modified styrene-butadiene-methyl methacrylate block copolymer, ethanolamine modified methyl methacrylate-butyl acrylate-methyl methacrylate block copolymer, hydroxyl-terminated poly(butadiene), poly(butadiene/epoxy) random copolymer, and mixtures thereof.

4. The process as recited in claim 1, wherein said rubbery-polymer is a block copolymer comprising from acrylates or methacrylates with or without reactive functionalities.

5. The process as recited in claim 3, wherein said siloxane fiber sizing solution further comprises hydrolyzed TES and GPS siloxanes.

6. The process as recited in claim 5, wherein said siloxane fiber sizing solution further comprises nanoparticles selected from the group consisting of carbon nanotubes, silica nanoparticles, fullerenes, boron nitride titania, zirconia, montmorillonite, wollastonite, nanoclays, silica gel, fused silica, fumed silica, quartz, alumina, kieselguhr, diatomaceous earth, bentonite, and mixtures thereof.

7. The process as recited in claim 1, wherein said fibers are glass fibers or carbon fibers.

8. The process as recited in claim 1, wherein said siloxane fiber sizing solution is an aqueous system.

9. The process as recited in claim 1, wherein said siloxane fiber sizing solution is a non-aqueous system.

10. An siloxane fiber sizing solution, comprising at least one rubbery-polymer.

11. An siloxane fiber sizing solution as recited in claim 10, wherein said rubbery-polymer is selected from the group consisting of rubbery homopolymer, rubbery random copolymers, block copolymer with rubbery-blocks, functionalized rubbery homopolymer, functionalized rubbery random copolymers, functionalized block copolymer with rubbery-blocks, and mixtures thereof.

12. The siloxane fiber sizing solution as recited in claim 10, wherein said rubbery-polymer is selected from the group consisting of styrene-butadiene-methyl methacrylate block copolymer, methyl methacrylate-butyl acrylate-methyl methacrylate block copolymer, ethanolamine modified styrene-butadiene-methyl methacrylate block copolymer, ethanolamine modified methyl methacrylate-butyl acrylate-methyl methacrylate block copolymer, hydroxyl-terminated poly(butadiene), poly(butadiene/epoxy) random copolymer, and mixtures thereof.

13. The siloxane fiber sizing solution as recited in claim 10, wherein said rubbery-polymer is a block copolymer made from acrylates or methacrylates with or without reactive functionalities.

14. The siloxane fiber sizing solution as recited in claim 11, wherein said siloxane fiber sizing solution further comprises hydrolyzed TES and GPS siloxanes.

15. The siloxane fiber sizing solution as recited in claim 14, wherein said siloxane fiber sizing solution further comprises nanoparticles selected from the group consisting of carbon nanotubes, silica nanoparticles, fullerenes, boron nitride titania, zirconia, montmorillonite, wollastonite, nanoclays, silica gel, fused silica, fumed silica, quartz, alumina, kieselguhr, diatomaceous earth, bentonite, and mixtures thereof.

16. The siloxane fiber sizing solution as recited in claim 10, wherein said fibers are glass fibers or carbon fibers.

17. The siloxane fiber sizing solution as recited in claim 10, wherein said siloxane fiber sizing solution is an aqueous system.

18. The siloxane fiber sizing solution as recited in claim 10, wherein said siloxane fiber sizing solution is a non-aqueous system.

19. A composite material comprising, fibers that are sized with siloxane fiber sizing solution, wherein said fiber sizing solution comprises at least one rubbery-polymer.

20. The composite material as recited in claim 19, wherein said rubbery-polymer is selected from the group consisting of rubbery homopolymer, rubbery random copolymers, block copolymer with rubbery-blocks, functionalized rubbery homopolymer, functionalized rubbery random copolymers, functionalized block copolymer with rubbery-blocks, and mixtures thereof.

21. The composite material as recited in claim 19, wherein said rubbery-polymer is selected from the group consisting of styrene-butadiene-methyl methacrylate block copolymer, methyl methacrylate-butyl acrylate-methyl methacrylate block copolymer, ethanolamine modified styrene-butadiene-methyl methacrylate block copolymer, ethanolamine modified methyl methacrylate-butyl acrylate-methyl methacrylate block copolymer, hydroxyl-terminated poly(butadiene), poly(butadiene/epoxy) random copolymer, and mixtures thereof.

22. The composite material as recited in claim 19, wherein said rubbery-polymer is a block copolymer made from acrylates or methacrylates with or without reactive functionalities.

23. The composite material as recited in claim 21, wherein said siloxane fiber sizing solution further comprises hydrolyzed TES and GPS siloxanes.

24. The composite material as recited in claim 23, wherein said siloxane fiber sizing solution further comprises nanoparticles selected from the group consisting of carbon nanotubes, silica nanoparticles, fullerenes, boron nitride titania, zirconia, montmorillonite, wollastonite, nanoclays, silica gel, fused silica, fumed silica, quartz, alumina, kieselguhr, diatomaceous earth, bentonite, and mixtures thereof.

25. The composite material as recited in claim 19, wherein said fibers are glass fibers or carbon fibers.

26. The composite material as recited in claim 19, comprising glass/polymer composite selected from the group consisting of E-glass/epoxy, E-glass/vinyl ester, and E-glass/polyurethane composite.

27. The composite material as recited in claim 19, wherein said siloxane fiber sizing solution is an aqueous system.

28. The composite material as recited in claim 19, wherein said siloxane fiber sizing solution is a non-aqueous system.

29. Glass fibers or carbon fibers coated with siloxane sizing solution, wherein said sizing solution comprises at least one rubbery-polymer.

30. The glass fibers or carbon fibers process as recited in claim 29, wherein said rubbery-polymer is selected from the group consisting of rubbery homopolymer, rubbery random copolymers, block copolymer with rubbery-blocks, functionalized rubbery homopolymer, functionalized rubbery random copolymers, functionalized block copolymer with rubbery-blocks, and mixtures thereof.

31. The glass fibers or carbon fibers process as recited in claim 29, wherein said rubbery-polymer is selected from the group consisting of styrene-butadiene-methyl methacrylate block copolymer, methyl methacrylate-butyl acrylate-methyl methacrylate block copolymer, ethanolamine modified styrene-butadiene-methyl methacrylate block copolymer, ethanolamine modified methyl methacrylate-butyl acrylate-methyl methacrylate block copolymer, hydroxyl-terminated poly(butadiene), poly(butadiene/epoxy) random copolymer, and mixtures thereof.

32. The composite material as recited in claim 29, wherein said rubbery-polymer is a block copolymer made from acrylates or methacrylates with or without reactive functionalities.

33. The glass fibers or carbon fibers process as recited in claim 31, wherein said siloxane fiber sizing solution further comprises hydrolyzed TES and GPS siloxanes.

34. The glass fibers or carbon fibers process as recited in claim 33, wherein said siloxane fiber sizing solution further comprises nanoparticles selected from the group consisting of carbon nanotubes, silica nanoparticles, fullerenes, boron nitride titania, zirconia, montmorillonite, wollastonite, nanoclays, silica gel, fused silica, fumed silica, quartz, alumina, kieselguhr, diatomaceous earth, bentonite, and mixtures thereof.

35. The glass fibers or carbon fibers process as recited in claim 29, wherein said siloxane fiber sizing solution is an aqueous system.

36. The glass fibers or carbon fibers process as recited in claim 29, wherein said siloxane fiber sizing solution is a non-aqueous system.

37. The process for preparing an alkanolamine-modified rubbery random copolymer or block copolymer with rubbery-blocks, comprising, contacting
(i) said rubbery random copolymer; or
(ii) said block copolymer with rubbery-blocks; with
(iii) alkanolamine;
at elevated temperature in a basic media, wherein said alkanolamine is in molar excess,
wherein said alkanolamine ranges from C₁ to C₆ alkanolamine or mixtures thereof.

38. The process as recited in claim 37, wherein said rubbery random copolymer or said block copolymer with rubbery blocks is selected from styrene-butadiene-alkyl (alk)acrylate copolymer and alkyl(alk)acrylate-butyl acrylate-alkyl (alk)acrylate.

39. The process as recited in claim 38, wherein said rubbery random copolymer or said block copolymer with rubbery blocks is selected from styrene-butadiene-methyl methacrylate copolymer and methyl methacrylate-butyl acrylate-methyl methacrylate, and wherein said alkanolamine is ethanolamine.

40. An alkanolamine-modified rubbery random copolymer or block copolymer with rubbery-blocks.

41. The alkanolamine-modified rubbery random copolymer or block copolymer with rubbery-blocks as recited in claim 40, wherein said alkanolamine-modified rubbery random copolymer or block copolymer with rubbery-blocks is selected from styrene-butadiene-alkyl(alk)acrylate copolymer and alkyl(alk)acrylate-butyl acrylate-alkyl(alk)acrylate.

42. The alkanolamine-modified rubbery random copolymer or block copolymer with rubbery-blocks as recited in claim 41, wherein said rubbery random copolymer or said block copolymer with rubbery blocks is selected from styrene-butadiene-methyl methacrylate copolymer and methyl methacrylate-butyl acrylate-methyl methacrylate, and wherein said alkanolamine is ethanolamine.
